(19) United States
(12) Patent Application Publication
(10) Pub. No.: US 2004/0254960 A1
(43) Pub. Date: Dec. 16, 2004

(54) System and method for delivering video and music files over network

(76) Inventor: Paul E. Scaturro, Garden City, NY (US)

Correspondence Address: MICHAEL A. SCATURRO, 679 Third Place South, Garden City, NY, 11530, US

(21) Appl. No.: 10/864,949

(22) Filed: Jun. 10, 2004

Related U.S. Application Data
(60) Provisional application No. 60/477,163, filed on Jun. 10, 2003.

(51) Int. Cl. G06F 17/00

(52) U.S. Cl. 707/104.1

(57) ABSTRACT

A system, method and architecture are provided for efficiently and cost effectively streaming multimedia files to users over a network. The architecture advantageously removes the burden of a hosting server from having to host a large volume of media files. The hosting server is only required to store deep links to a plurality of artists' servers which actually store and maintain the artists' media files in addition to the artists' websites. In an embodiment, when a user makes a request for a multimedia file from the hosting server, the server forwards that request to the appropriate artist server site and the multimedia file is downloaded from the artist server site to the user. During this process, the user remains at the URL associated with the hosting server.

### CROSS REFERENCE TO RELATED APPLICATIONS

This is a non-provisional application of provisional application Ser. No. 60/477,163 by Paul Scaturro filed Jun. 10, 2003.

### FIELD OF THE INVENTION

The present invention relates generally to the field of data distribution and more particularly to a system and method for delivering multimedia files over a network.

### BACKGROUND OF THE INVENTION

A common problem experienced by present day multimedia hosting websites, particularly those that host video and music files, is the high cost of internet bandwidth for distributing the video and music files to users.

FIG. 1 is an illustrative example of a prior art system architecture 100 that suffers from the high cost of internet bandwidth. As shown in the system of FIG. 1, a plurality of internet users 10 access a single multi-media server 20 via network 30. The hosting company of the multi-media server 20 is charged a fee commensurate with the bandwidth usage associated with servicing the multiple users 10. In other words, as the number of users 10 placing demands on the media server 20 for additional bandwidth increases, the cost of supplying the additional bandwidth to support the increased user demand rises. From a business perspective such costs may become prohibitive for the hosting company.

To this end, it would be desirable for the hosting company of the media server 20 to implement an alternative system architecture and associated method which at least partially obviates the high costs associated with requiring additional bandwidth.

### SUMMARY OF THE INVENTION

The foregoing and other problems are overcome by a system architecture and method for streaming multimedia (e.g., music and video) files to users over a network.

According to one aspect of the invention, clients (artists/musicians) associated with a video/music portal website host their own media files on their own personal servers (or websites) separate and apart from the video/music portal website. This is in contrast to the prior art approach, discussed above, in which a single media server hosts multi-media files for all of the clients (artists/musicians). By having the clients (artists/musicians) host their own multi-media files, the high bandwidth costs associated with having to host all of the multi-media files on a single media server of a video/music portal website is significantly reduced.

According to another aspect, it is to be appreciated that in accordance with the system architecture of the invention, the plurality of clients (artists/musicians) storing their respective multi-media files on their personal servers, may be collectively viewed as a single virtual server for satisfying the demands of the end users of the music/video portal website.

According to yet another aspect, an end user of the music/video portal website remains at the music/video portal website upon selecting a client (aritist/musician) media file of interest whose link appears on the music/video portal website. In this manner, the client (artist/musician) media files, whose links appear on the music/video portal site, are actually played to the end user from the client (artist/musician) personal servers via a link to the artists' personal server storing the multi-media file of interest to the user.

Thus, the invention according to specific embodiments can be understood as involving a new business method for reducing the overhead costs incurred by a hosting company for additional bandwidth required as the number of end users placing demands on the host server to download multimedia files increase over time. By virtue of not having to pass these costs on to the artists affiliated with the host company, the artists (e.g., musicians) are assisted in selling and/or advertising the artists' media files to users of the hosting server in a cost effective manner.

### BRIEF DESCRIPTION OF THE DRAWINGS

Referring now to the drawings where like reference numbers represent corresponding parts throughout:

FIG. 1 illustrates an exemplary network for performing end-to-end transmission of streaming or downloaded media according to the prior art;

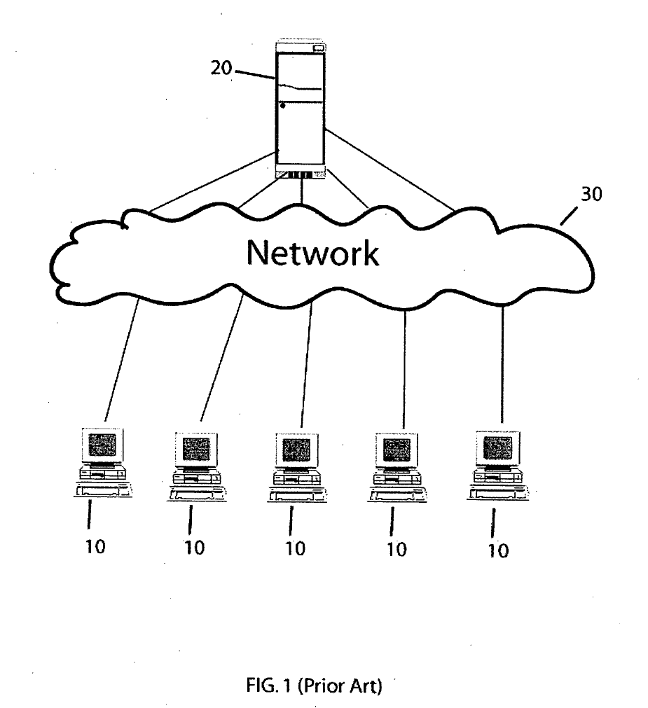

FIG. 2 illustrates an exemplary network for performing end-to-end transmission of streaming or downloaded media according to an embodiment of the invention;

FIG. 3 is a snapshot illustration of the hosting service website homepage; and

FIG. 4 illustrates a media player pop-up window which appears on the website homepage of FIG. 3 in response to a user selecting one of a plurality of artist's hyperlinks listed on the hosting service website.

### DETAILED DESCRIPTION OF THE INVENTION

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, and methods are omitted so as not to obscure the description of the present invention with unnecessary detail.

To provide an overall understanding of the invention, certain illustrative embodiments will now be described. To this end, the below description provides an example of an architecture and associated method which at least partially obviates the high costs of bandwidth usage associated with servicing a large number of users of a music hosting website. However, other applications of the invention may be developed by those of ordinary skill in the art and it will be understood by one of ordinary skill that the systems and methods described herein can be adapted and modified for other suitable applications and that such other additions and modifications will not depart from the scope hereof.

Definitions Relevant to the Present Invention are as Follows:

IP address: The Internet Protocol (IP) is the method or protocol by which data is sent from one computer to another on the Internet. Each computer on the Internet has at least one IP address that uniquely identifies it from all other computers on the Internet.

URL (Uniform Resource Locator): An Internet address (for example, http://www.hmco.com/trade/), that indicates the server protocol to use in accessing the resource (http), the domain name of the server (www.hmco.com), and the name and location of the resource on that particular server (trade).

Web Page: A block of data available on the World Wide Web, identified by a URL. A web page is stored on a server and is a file written in HTML and any related files for scripts and graphics. It is often hyperlinked to other documents on the Web.

Server: A computer or device on a network that manages network resources.

Web browser: A software application used to locate and display web pages.

Web Site: A collection of web pages which share a URL, such as, www.ibm.com.

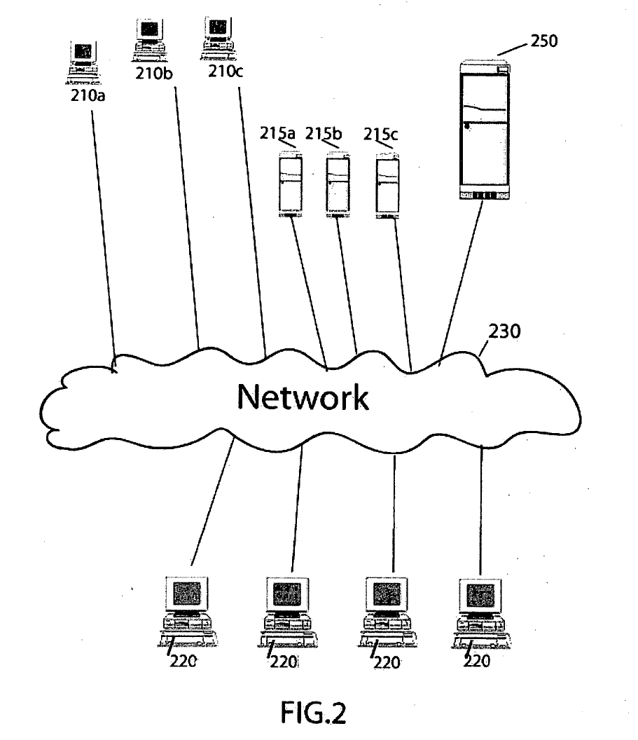

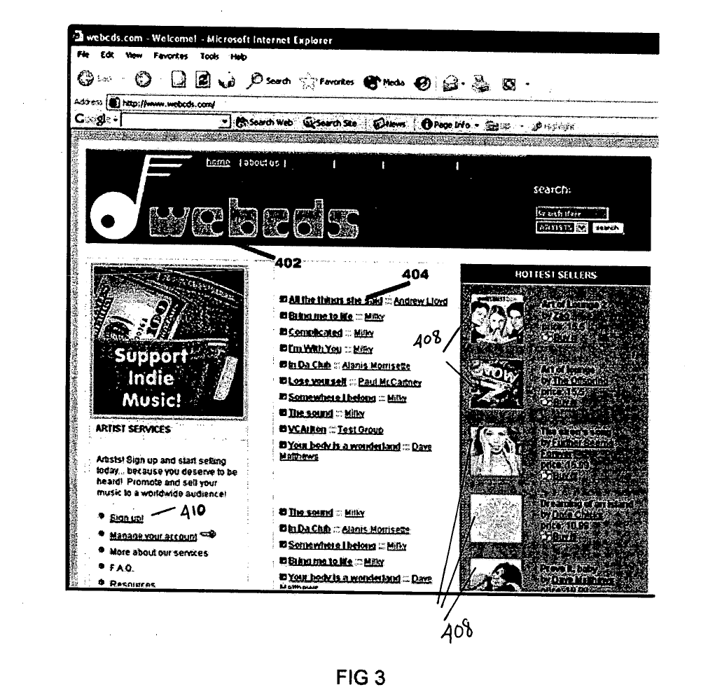

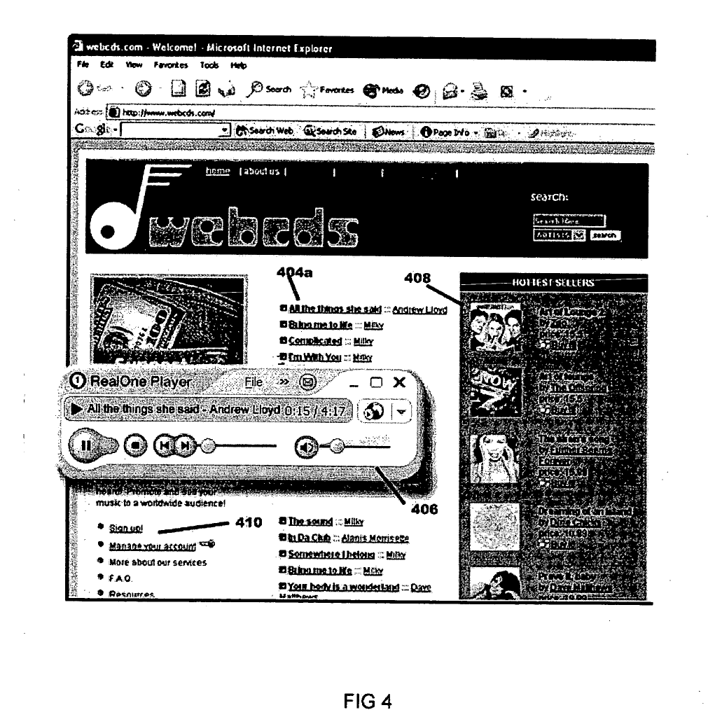

Before describing the invention in detail, an environment in which embodiments of the invention may be implemented is described in connection with FIG. 2. The system 200 of FIG. 2 includes a music portal server 250 operating under the control of a server application which supports a music/video portal website (see FIGS. 3 and 4). The music portal server 250 can be any of the commercially available server systems, including the Apache server or other server that operates on conventional processing platforms such as an IBM PC-compatible computer running the Windows operating systems, or a SUN server running a Unix operating system. The system 200 of FIG. 2 further depicts a plurality of client processors 210a-c. The client processors 210 may comprise any suitable network enabled processor, for example, but not limited to, personal computers (PCs), set-top boxes (STB), personal digital assistants (PDAs), mobile telephones, network-enabled televisions or other computer or processor system capable of receiving content over the network. The system of FIG. 2 further depicts a plurality of client (artists) servers 215a-c each client server 215 having an associated client processor. For example, client processor 210a is associated with client server 215a. The clients communicate from their respective processors 210 over a network 230 such as the Internet. The various clients are also in communication with the music portal server 250 via the network 230. Also shown in the system 200 of FIG. 2 are end user processors 220 operated by respective end users of the system.

Operation

The system 200 of FIG. 2 removes the burden of the music portal website 250 from having to host the client (artists') multi-media files (e.g., mp3, mpeg files or any other type of data file that may be streamed over a network 230). Instead, the music portal server 250 stores deep links to a plurality of client (artists') servers 215 which actually host and maintain the multi-media files in addition to the artists' websites.

In operation, an client (artist), who is typically a musician desiring to gain recognition and/or sell musical/video content (the multi-media files) initially logs on to the hosting server 250, via his or her client (artist) device 210, to register with the hosting server 250. The music portal server 250, in the exemplary embodiment, is an online music and/or video retailer desiring to assist the clients (artists) in selling and/or advertising the clients (artists') media files to users of the music portal server 250. Registration may include, for example, filling out pertinent information including, but not limited to, multimedia file descriptions (song type, category, etc.), background information, artist contact information and photographs of the respective artists.

Next the client (artist) uploads to the music portal server 250, for purposes of posting, a URL link for each multi-media file to be listed on the music portal server 250.

From a user's perspective, a user logging onto the music portal server website (see FIGS. 3 and 4), via the user processor 220, is shown the music portal server website homepage 300, a display image window of which is shown at FIG. 3. In the illustrative example, the homepage 300 is shown to include a title 402 “webcds.com” in the upper left portion of the homepage 300. In the lower middle portion of the homepage 300 there is shown a plurality of hyperlinks, generally labeled as element 404, where each hyperlink 404 in the list is associated with a particular artist and that artists' media files. For example, the first multimedia hyperlink displayed in the exemplary list 404 lists the media file “All The Things She Said” along with the artists' name “Andrew Loyd” and the third hyperlink in the list 404 lists the media file “Lose Yourself” along with the artists' name, “Paul McCartney”.

In addition to displaying the multimedia hyperlinks 404, the music portal website 300, in the exemplary display, also displays additional hyperlinks 408 which link the user 220 to further website pages and links associated with music portal website 300 which describe the various clients (artists') background information, contact information, photographs, additional media files and so on. These additional hyperlinks 408 are preferably provided to induce the user to learn more about the participating clients (artists). Further, website 300 is shown to display, on the left hand side, a number of hyperlinks 410, enabling clients (artists) to register with the music portal server 250, which process has been described above.

With continued reference to FIG. 3, upon selecting any of the displayed hyperlinks 404, the selected media stream (e.g. “Lose Yourself”) is downloaded from the client (artists') server 215 to a media player 406 (see FIG. 4) on the user's processor 220 while the user remains at the music portal server 250 viewing the music portal server's website 300 to make other multi-media selections. It is noted that, in alternate embodiments, the media player 406 can be displayed in any fashion, e.g., on the top of a portion of the music portal website 300 or embedded in the music portal website 300.

It should be appreciated that, in accordance with the method of the invention, the user is not transferred to the client (artists') server 215 website upon selecting any of the displayed hyperlinks 404 from the website of the music portal 250. Instead, the user remains at the URL of the music portal server 250 and transparently receives a stream and/or download from the website of the client (artist) server 215 associated with the user selected multi-media file (song). This process will be further described by way of example as follows.

### EXAMPLE

Referring now to FIG. 4, an example is shown of a scenario in which a user invokes one of the displayed hyperlinks, e.g., “All The Things She Said-by Andrew Loyd” from the hosting server website homepage 300. Upon invoking the desired hyperlink from the music portal server website homepage 300, the user is shown media player 406. The media player 406 is embodied any commercial media player tool, such as, but not limited to Windows Media Player, Real Player, Quickme or other tool for playing or otherwise accessing the downloaded content item. The media player 406 plays the user selected media file (song) while the user remains on the hosting server website 300. It should be appreciated that, the user selected media file (song) corresponding to the invoked hyperlink is not streamed (and/or downloaded) from the hosting server 250, but is instead transparently streamed and/or downloaded from the website of the client (artist) server 215 associated with the selected media file (song) which stores the user selected media file. That is, in accordance with the method of the invention, the music portal server 250 does not store media files (e.g., songs, videos), but instead re-directs user requests to the appropriate client (artist) server 215 to download the media files hosted (stored) there. In this way, a key advantage of the invention is realized. That is, the hosting company does not incur excessive bandwidth costs associated with storing a large volume of media files at a single location and is capable of satisfying the demands of a large number of end users without incurring data bottlenecks.

A process (not shown) running on the music portal server 250 must identify the media file selection made by the user and initiate a request to the client (artist) server website associated with the requested media file (song, video) to start streaming the selected multi-media file from the artist server 215 to the users' processor 220 making the selection.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

What is claimed is:

1. A system for streaming multimedia files to users over a network, the system comprising,
at least one web server connected to a communications network and a multimedia website executing on said at least one web server, wherein the multimedia website, in response to log-on by a user from a user's processor connected to said communications network, presents a home page for the user, the home page having a list of multimedia files enabled by hyperlinks, wherein, upon invocation of one of said hyperlinks by the user, the multimedia file corresponding to the invoked hyperlink is downloaded from a client web server connected to said communications network, wherein said client web server stores the requested multimedia file.

2. The system of claim 1, wherein the system comprises a plurality of client web servers each of said client web servers storing at least one of said list of multimedia files.

3. The system according to claim 1, wherein the download of the multimedia file from the client server is transparent to the user.

4. The system according to claim 1, wherein the user remains at the URL of the home page of said multimedia website upon invoking one of said hyperlinks.

5. The system according to claim 1, wherein the user invokes one of said hyperlinks on said multimedia website via a web client.

6. The system according to claim 5, wherein the web client is a web browser.

7. A method for streaming multimedia files to users over a network, the method comprising the acts of:
presenting a home page to a user from a web server connected to a communications network, the home page having a list of multimedia files enabled by hyperlinks;
invoking one of said hyperlinks on the home page by the user to select one of said listed multimedia files;
downloading said selected multimedia file from a client web server connected to said communications network, said client web server storing the requested multimedia file.

8. The method according to claim 7, wherein said multimedia files describe songs and song authors.

9. The method according to claim 7, wherein the communication network is the Internet.

10. The method according to claim 7, further comprising the act of a client registering with the web server to enable listing of said multimedia files.

11. The method according to claim 10, wherein the act of registering further comprises the act of providing at least one multimedia file description and background information about said client.

12. The method according to claim 10, wherein the multimedia file descriptions include descriptions of song type and song category.

13. The method according to claim 10, wherein the act of registering further comprises the act of providing client contact information and client photographs.
